(19) United States
(12) Patent Application Publication
(10) Pub. No.: US 2011/0129651 A1
(43) Pub. Date: Jun. 2, 2011

(54) PROFILED OBJECT WITH A PROTECTIVE MATERIAL AND SEALING LAYER

(75) Inventors: Klaus Becker-Weimann, Karlsruhe (DE); Jens Fandrey, Pforzheim (DE)

(73) Assignee: KLEBCHEMIE M. G. BECKER GMBH & CO. KG, Weingarten/Baden (DE)

(21) Appl. No.: 13/002,882

(22) PCT Filed: Jul. 7, 2009
(86) PCT No.: PCT/EP09/58614

§ 371 Date: Feb. 9, 2011

(30) Foreign Application Priority Data
Jul. 7, 2008 (DE) 20 2008 009 137.3

(51) Int. Cl. B32B 1/04

(52) U.S. Cl. 428/192

(57) ABSTRACT

The present invention relates to profiled articles comprising a profile region with profiled surface, where a covering material has been applied on the profiled surface, and that area of the covering material that faces away from the profiled surface has a sealing layer made of a reactive melt, where at least one profile radius of the profile region is smaller than 3 MM.

The present invention relates to a profiled article comprising a profile region with profiled surface with covering material and sealing layer.

Profiled articles are often intended to be provided with a covering material. The covering material here can be a veneer.

Veneers are in particular widely used in the furniture industry and wood-processing industry, examples being found in the wrapping sector, for example for wall-connector strips, in lamination processes, for furniture surfaces, ceilings, tables, etc., or in edge coating or edgebanding, for example for straight edges, softforming or postforming processes for table tops, furniture doors, or the like. To this end, the veneer itself is first produced, for example by shaving from a solid piece of wood. The large-surface-area veneer sheets are then either placed in intermediate inventory, for example wound up to give a roll of veneer, or are subjected to immediate further processing. The further processing of the veneers to produce veneered parts involves sticking the veneer to the wood substrate or wood-product substrate and then subjecting the semifinished part to sanding and lacquering, or direct lacquering.

The lacquering procedure is complicated since it is not only flat areas that have to be lacquered but also profiled areas of the veneer-wrapped profile. The method of sticking the veneer to the profiles here can involve the softforming process on an edgebanding machine, the postforming process, or any other method. The lacquers used in the lacquering process generally have to be applied in a plurality of layers, and this requires complicated process technology and the corresponding amount of space.

UV-curing lacquers provide a widely used lacquer system and are mostly applied to the parts by roll-application methods, and less frequently by spray-application methods. The subsequent hardening procedure then uses UV light or UV lamps.

The machine cost for lacquering with UV lacquers is very high, and a very large amount of space is required. Another reason for the large amount of space required is that lacquering procedures using UV-curing systems mostly require a plurality of applications—a familiar requirement in practice being three to four applications. For reasons associated with viscosity, but specifically in order to obtain UV-curing through the entire material, the layer thickness that can be applied with each lacquer application is only about 10 to 20 μm, and again this creates a requirement for a plurality of lacquer applications. UV lamps, and the energy needed for the hardening process, are very expensive.

In order to avoid said disadvantages, WO-A 02/094549 proposes veneers and veneered parts, and also a process, and an apparatus, for producing veneers and veneered parts, where the single- or multilayer veneers are first produced in a manner known per se and then, prior to further processing, a sealing layer is applied.

However, the prior art has hitherto suffered from the unjustified assumption that highly profiled articles, for example a window profile, cannot be subjected to finishing processes using a covering material which is, for example, a previously lacquered wood veneer, since the high level of profiling (and the small profile radii associated therewith) might cause stress whitening during processing. In practice, the extremely high costs for extrusion tooling meant that these geometric shapes, for example of a PVC profile or aluminum profile, were very difficult to change, and economic reasons therefore appear to make it impossible to adapt the tooling to make it “wrapping-friendly”. It therefore appears that technical reasons would always make it impossible to wrap profiles of this type with genuine wood that had been previously surface-finished, without any requirement for posttreatment steps, such as sanding or the like. Similar considerations apply to other covering materials, such as papers or foils.

It is therefore an object of the present invention to provide correspondingly profiled articles with sealed covering material.

Said object is achieved via a profiled article comprising a profile region with profiled surface, where a covering material has been applied on the profiled surface, and that area of the covering material that faces away from the profiled surface has a sealing layer made of a reactive melt, characterized in that at least one profile radius of the profile region is smaller than 3 mm.

Surprisingly, it has namely been found that highly profiled articles can also be provided with a covering material in their profile region, as long as this material already has a sealing layer.
The sealing layer has a protective function which by way of example provides the profiled article with flexibility, resistance to effects of temperature, water-repellent properties, and a very low level of embrittlement on exposure to UV radiation.

This therefore also permits use in the outdoor sector.

The application of the sealing layer to the covering material has been described in some detail in WO-A 02/094549.

The profiled article can by way of example be a component for the indoor or outdoor sector, in particular a window element or door element, or a profiled floor panel, an item of furniture, or a part of a motor vehicle. The profiled article is particularly preferably a window element.

The profiled article can in principle be composed of any desired material. However, it is advantageous that, at least in the profile region, the article is composed of wood, plastic, or metal, or at least one of said materials is present.

It is preferable that the profiled article is composed, at least in the profile region, of plastic or aluminum.

A plastic is moreover preferably a polyvinyl chloride (a PVC), in particular extruded PVC.

The thickness of the covering material is preferably at most 200 to 400 μm. The covering material is preferably a single- or multilayer wood veneer, in particular a genuine wood veneer, or a paper layer, where the paper is preferably a decorative paper, which can be a printed or unprinted paper, and the print - insofar as it is present—can have been produced digitally, with the aid of an inkjet, or in any other manner. The material can also be a plastics foil. It is particularly preferably a single- or multilayer wood veneer, in particular a genuine wood veneer.

The sealing layer is a reactive melt, a particular feature of which is that it is free from water and from solvent, and hardens with the moisture in the atmosphere.

The melt here is preferably polyurethane-based.

The reactive melt layer that is free from water and from solvent (sealing layer) can be applied to the surface that requires sealing at a temperature which is 100° C. or higher, for example 100° C. to 140° C. By way of example here, the amount of reactive melt applied per square meter of surface that requires coating is about 50 to 100 g. The density of the reactive melt is usually about 1.1 g/m² and its Brookfield viscosity at 120° C. is usually about 4000 mPas. However, substantially higher viscosities of the reactive melt layer are also possible: up to about 30 000 mPas. It is advantageous to apply the reactive melt layer with exclusion of air and with protection from atmospheric moisture, in order to prevent premature completion of the reaction. By way of example, the layer can be applied by doctoring, rolling, or spraying, or by means of a slot die or any other type of nozzle. Even when the reactive melt layer is in the hardened condition in the form of 100 percent solid it retains a certain residual elasticity. A reactive melt layer has proven specifically advantageous for the coating of veneers because it is possible to use a single application process to apply it to the surface of the veneer. Because of the remaining residual elasticity of the sealing layer, it is possible to carry out the subsequent adhesive-bonding processes even around profile geometries of which the profile radii are smaller than 3 mm.

The expression “profile radius” is known to the person skilled in the art. The profile radii of profiled articles are frequently stated by the producer. The radius here is characterized by R for the numeric dimension in accordance with DIN 406-11 (12.92).

Indeed, it is preferably possible to provide highly profiled articles with a covering material where the at least one profile radius is smaller than 1 mm.

The sealing layer brings about additional stabilization of the veneer surface, inhibiting surface cracking.

Similar considerations apply to other covering materials.

In addition to said advantages, the reactive melt layer has high UV resistance, high hardness and scratch resistance, and very high impact resistance. When comparison is made with conventional lacquering systems, the processing of the reactive melt layer requires less capital expenditure on machinery and less space.

The coating of the reactive melt is a simple high-temperature-low-temperature reaction with subsequent crosslinking process using moisture from the air or the material, without any need for UV curing or electron beam curing, or the like.

The surface properties of the reactive melt layer can be improved by smoothing the reactive melt layer after application to the surface of the covering material. This avoids surface unevenness which can result if the application of the hot reactive melt is not followed by any other process, and the surface obtained has even greater smoothness. It is then also possible to operate with smaller amounts of material: between 50 and 100 g/m² of reactive melt.

One preferred embodiment of the present invention therefore provides an article which comprises a sealing layer which has been surface-smoothed.

The maximum thickness of the sealing layer is preferably 20 μm to 70 μm.

It is advantageous that, between the application process and the smoothing process, heat is again introduced into the surface of the reactive melt layer, in order to achieve a further improvement in the result of the smoothing process. The smoothing process advantageously uses a roll, for example a steel roll, which can optionally have a polyurethane coating.

The coating of the covering material by the sealing layer can therefore use a roll, which is optionally wetted with a release agent. Details concerning suitable release agents, and concerning apparatuses for producing veneers with a sealing layer, have been described in some detail in WO-A 02/094549, and these can also be used analogously with covering materials which are not veneers.

The covering material provided with the sealing layer is applied to the profiled article by methods known per se in the prior art, and these can be used in a manner analogous to the lamination of foils.

1-15. (canceled)

16. A profiled article comprising a profile region with profiled surface, where a covering material has been applied on the profiled surface, and that area of the covering material that faces away from the profiled surface has a sealing layer made of a reactive melt, characterized in that at least one profile radius of the profile region is smaller than 3 mm.

17. The article as claimed in claim 16, characterized in that the profiled article is a component for the indoor or outdoor sector, an item of furniture, or a part of a motor vehicle.

18. The article as claimed in claim 17, characterized in that the component is a window element or door element, or a profiled floor panel.

19. The article as claimed in claim 18, characterized in that the component is a window element.

20. The article as claimed in claim 16, characterized in that the profiled article is composed, at least in the profile region, of wood, plastic, or metal, or at least comprises at least one of said materials.

21. The article as claimed in claim 20, characterized in that the profiled article is composed, at least in the profile region, of plastic or aluminum.

22. The article as claimed in claim 21, characterized in that the plastic is a PVC.

23. The article as claimed in claim 16, characterized in that the thickness of the covering material is at most 200 to 400 μm.

24. The article as claimed in claim 16, characterized in that the covering material is a single- or multilayer wood veneer, a paper layer, or a plastics foil.

25. The article as claimed in claim 24, characterized in that the wood veneer is a genuine wood veneer.

26. The article as claimed in claim 24, characterized in that the paper is a decorative paper.

27. The article as claimed in claim 16, characterized in that the reactive melt is polyurethane-based.

28. The article as claimed in claim 16, characterized in that the sealing layer has been surfaced-smoothed.

29. The article as claimed in claim 16, characterized in that the maximum thickness of the sealing layer is 20 μm to 70 μm.

30. The article as claimed in claim 16, characterized in that the at least one profile radius is smaller than 1 mm.
